(19) United States
(12) Patent Application Publication
(10) Pub. No.: US 2010/0052832 A1
(43) Pub. Date: Mar. 4, 2010

(54) PERMANENT ELECTROMAGNETIC INDEXING APPARATUS

(75) Inventor: Richard Wang, Taichung County (TW)

Correspondence Address: PAI PATENT & TRADEMARK LAW FIRM, 1001 FOURTH AVENUE, SUITE 3200, SEATTLE, WA, 98154, US

(73) Assignee: EARTH-CHAIN ENTERPRISE CO., LTD., Taichung County (TW)

(21) Appl. No.: 12/257,135

(22) Filed: Oct. 23, 2008

(30) Foreign Application Priority Data
Sep. 4, 2008 (TW) 097215994

(51) Int. Cl. B23B 31/28

(52) U.S. Cl. 335/291

(57) ABSTRACT

A permanent electromagnetic indexing apparatus includes a chassis, a carrier pivoted to the chassis, and a plurality of magnetic sets. Each of the magnetic sets includes a first permanent magnet, a magnetic-conductive member, a second permanent magnet, and a magnetizing coil. Each of the first permanent magnets is mounted to the magnetic-conductive member. Each of the magnetic-conductive members is mounted onto the second permanent magnet. Each of the magnetizing coils surrounds the second permanent magnet. The magnetic sets are mounted to the carrier to enable the magnetic-conductive members to become a working surface for placing a workpiece thereon. When each of the magnetizing coils is electrically conducted, the polarity of each of the magnetic-conductive members can be changed and then the workpiece can be fixed to or removed from the working surface. In this way, the workability can be enhanced to enable preferably flexible and variable processing.

### BACKGROUND OF THE INVENTION

1. Field of the Invention

The present invention relates generally to indexing apparatuses, and more particularly, to a permanent electromagnetic indexing apparatus.

2. Description of the Related Art

When it is intended to do the machining, no matter where a machining is done, a lathe, miller, grinder or other machine tool, it is necessary to use a jig to hold a workpiece onto the machine tool before the machining is successfully processed. The common jig includes vise or clamping kit. Before doing the machining, a user must put the jig and the workpiece in respective proper positions and then hold the workpiece onto the workbench of the machine tool by the jig.

In addition to the above vise or clamping kit, which holds the workpiece by the mechanical force, there is another magnetic workbench having a permanent magnet and a rotatable control mechanism. When the user rotates the control mechanism, the magnetic field distribution of the permanent magnet can be changed for magnetization or demagnetization, whereby the workpiece can be held or removed from the workbench.

As disclosed in U.S. Pat. No. 5,991,147, another magnetic workbench for mechanical processing includes a plurality of permanent magnets, onto which coils are fitted, and a magnetization/demagnetization circuit adapted for controlling the magnetic fields of the permanent magnets. In this way, the magnetic workbench can magnetically hold the workpiece without any mechanical jig.

However, if the user intends to apply the above magnetic workbenches to multi-surface processing of the workpiece, the magnetic workbench must be demagnetized after one side of the workpiece is processed and before another side of the workpiece is processed, and then the workpiece can be turned or moved to a predetermined position; next, the magnetic workbench is magnetized to hold the workpiece for next processing of another side of the workpiece. The above magnetic workbenches can do nothing but hold the workpiece and fails to enable more flexible and variable processing, thus being less convenient in operation. Besides, such magnetic workbenches provide less magnetic force and thus fail to afford the more heavy-duty mechanical processing.

### SUMMARY OF THE INVENTION

The primary objective of the present invention is to provide a permanent electromagnetic indexing apparatus, which can make the processing more flexible and variable.

The secondary objective of the present invention is to provide a permanent electromagnetic indexing apparatus, which can hold a workpiece without any assistance of any mechanical jig to simplify the processing procedure and to shorten the processing time.

The foregoing objectives of the present invention are attained by the permanent electromagnetic indexing apparatus composed of a chassis, a carrier, and at least two magnetic sets. The carrier includes a receiving portion and a connection part. The receiving portion is recessed from a surface thereof. The connection part is pivoted to the chassis. Each of the at least two magnetic sets includes a first permanent magnet, a magnetic-conductive member, a second permanent magnet, and a magnetizing coil. Each of the first permanent magnets is mounted to the magnetic-conductive member. Each of the magnetic-conductive members is mounted onto the second permanent magnet. Each of the magnetizing coils surrounds the second permanent magnet. The magnetic sets are mounted to the receiving portion of the carrier to enable the magnetic-conductive members to become a working surface for placing a workpiece thereon. When each of the magnetizing coils is electrically conducted, the polarity of each of the magnetic-conductive members can be changed and then the workpiece can be fixed to or removed from the working surface.

### BRIEF DESCRIPTION OF THE DRAWINGS

FIG. 1 is a perspective view of a first preferred embodiment of the present invention.

FIG. 2 is a top view of the first preferred embodiment of the present invention.

FIG. 3 is a sectional view of the first preferred embodiment of the present invention.

FIG. 4 is a sectional view of a part of the first preferred embodiment of the present invention, illustrating the structure of a magnetic set.

FIG. 5 is a perspective view of a part of the first preferred embodiment of the present invention, illustrating the structure of the magnetic set.

FIG. 6 is a perspective view of a part of the first preferred embodiment of the present invention, illustrating that a plurality of chocks are mounted onto a working surface.

FIG. 7 is a schematic view of the first preferred embodiment of the present invention at work.

FIG. 8 is another schematic view of the first preferred embodiment of the present invention at work.

FIG. 9 is a front view of a second preferred embodiment of the present invention.

FIG. 10 is a schematic view of the second preferred embodiment of the present invention at work, illustrating that the present invention is applied to a horizontal automatic switching workbench.

FIG. 11 is a perspective view of a third preferred embodiment of the present invention.

FIG. 12 is another perspective view of the third preferred embodiment of the present invention, illustrating a polygonal carrier.

### DETAILED DESCRIPTION OF PREFERRED EMBODIMENTS

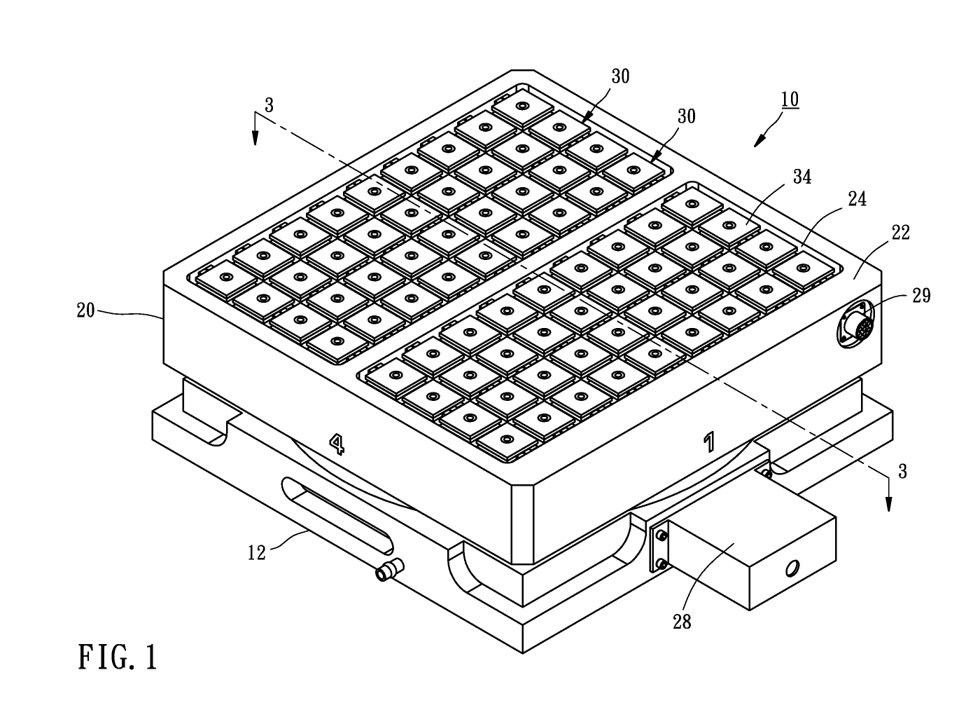

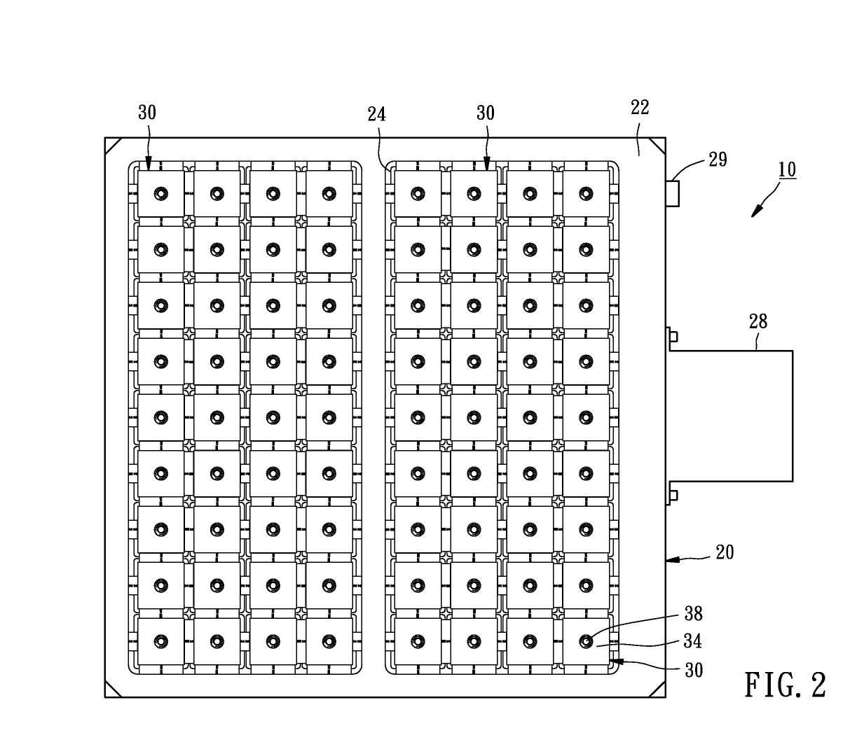

Referring to FIGS. 1-3, a permanent electromagnetic indexing apparatus 10 in accordance with a first embodiment of the present invention is composed of a chassis 12, a carrier 20, and a plurality of magnetic sets 30.

The carrier 20 includes a top side 22, two receiving portions 24 recessed from the top side 22, and a plurality of fixing portions 25 mounted to a bottom side of each of the receiving portions 24 and arranged in matrix. Each of the fixing portions 25 can be a threaded hole or a pin. In this embodiment, each of the fixing portions 25 is a threaded hole. The carrier 20 further includes a connection part 26 located at a bottom side thereof. The connection part 26 is pivoted to the chassis 12 by a rotary shaft 27 to enable the carrier 20 to be rotated with respect to the chassis 12. The chassis 12 includes a positioning member 28 for positioning the carrier 29 at a predetermined angle. The carrier 20 also includes an electric connector 29 mounted to one side thereof.

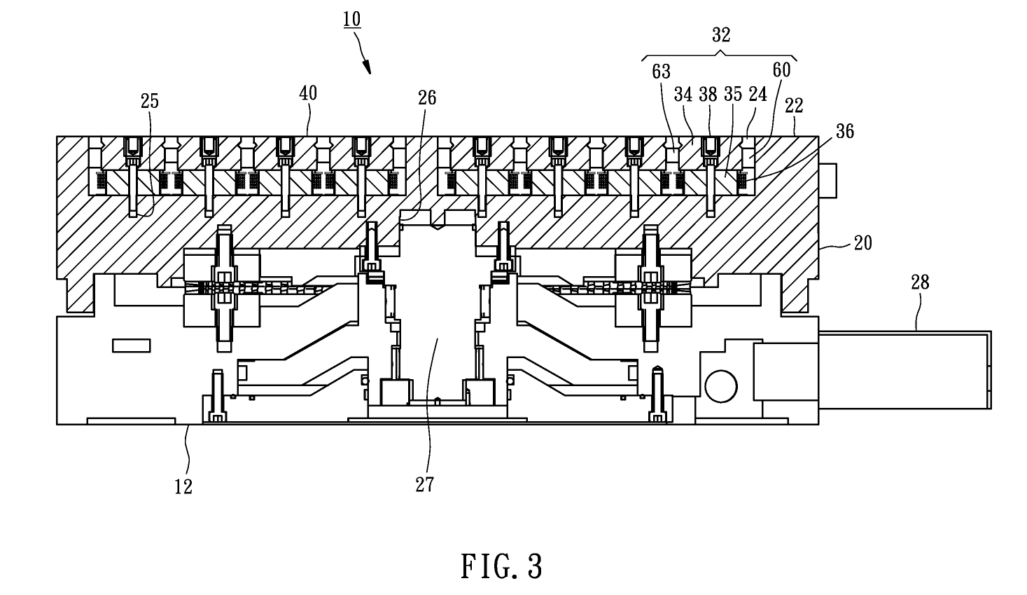

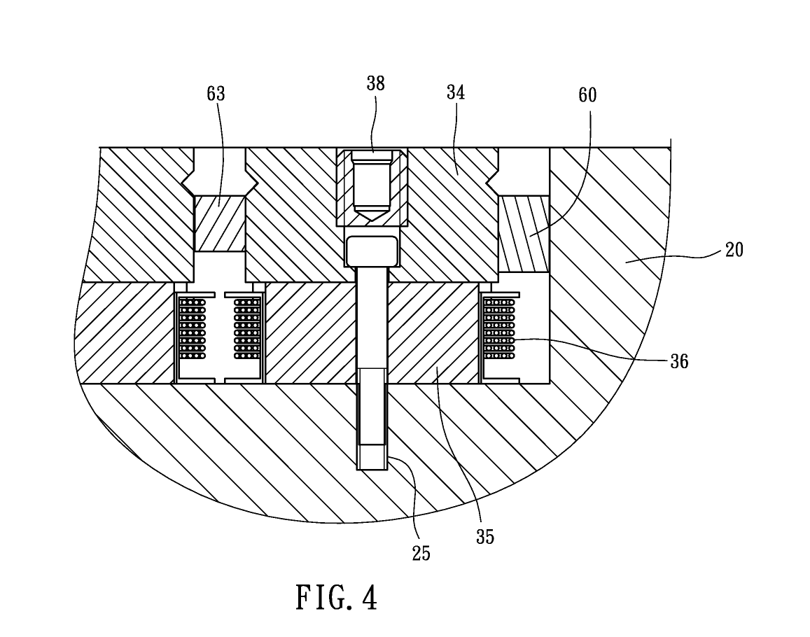

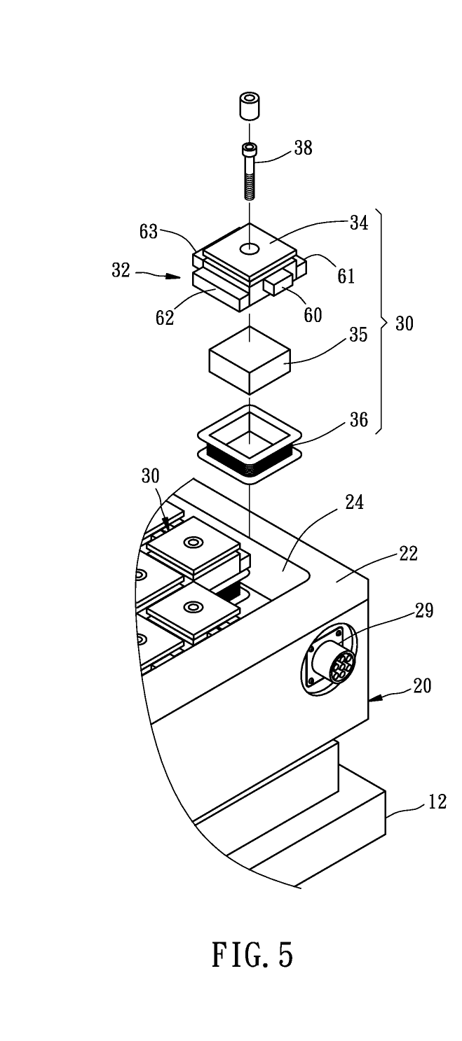

Referring to FIGS. 3-5, each of the magnetic sets 30 includes a first permanent magnet 32, a magnetic-conductive member 34, a second permanent magnet 35, and a magnetizing coil 36. Each of the first permanent magnets 32 is composed of four magnetic strips 60, 61, 62 & 63. In this embodiment, each of the first permanent magnets 32 is made of rubidium-iron-boron (Knife) alloy. Each of the second permanent magnets 35 is made of alnico. Each of the magnetic-conductive members 34 is made of iron.

In each of the first permanent magnets 32, the four magnetic strips 60-63 are mounted to four sides of the magnetic-conductive member 34 respectively. Each of the magnetic strips 60 is located higher than the other magnetic strips 61-63 for arrangement of proper magnetic field, by which the magnetic-conductive member 34 can be magnetized. Each of the magnet-conductive members 34 is mounted on the second permanent magnet 35. Each of the magnetizing coils 36 surrounds the second permanent magnet 35 and is electrically connected with the electric connector 29 of the carrier 20. The magnetizing coils 36 are electrically connected in series with the electric connector 29. Alternatively, the magnetizing coils 36 are divided into some groups, each of which includes some magnetizing coils 36. The magnetizing coils 36 in each group are electrically connected in series, and then all of the magnetizing coils 36 are electrically connected group by group in parallel and finally connected to the electric connector 29.

Each of the magnetic sets 30 is mounted to the receiving portion 24 of the carrier 20. Each of the magnetic-conductive members 34 and each of the second permanent members 35 are connected with each other and then jointly mounted to the fixing portion 25 by a fixture 38 therethrough. The magnetic sets 30 are arranged in the receiving portions 24 in matrix and then jointly become a working surface 40, on which a workpiece can be put.

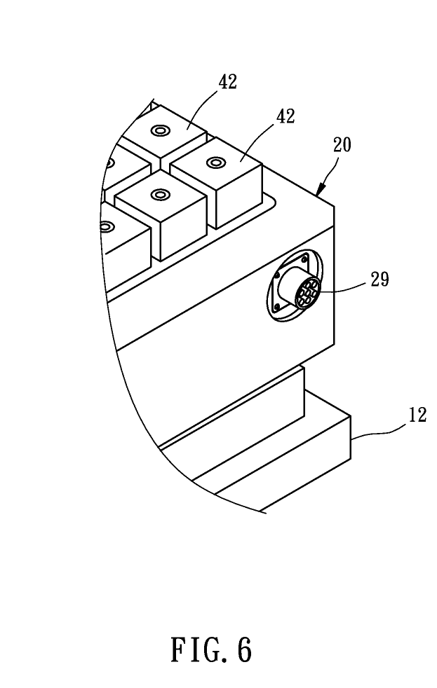

When each of the magnetizing coils 36 is electrically conduced by forward or reverse current, each of the second permanent magnets 35 is inducted to present N-pole or S-pole to further change the polarity of the magnetic-conductive member 34. In this way, magnetic fields are generated or not each between every two adjacent magnetic-conductive members 34. Referring to FIG. 6, a chock 42 can be additionally mounted onto each of the magnetic-conductive members 34 to facilitate processing the workpiece.

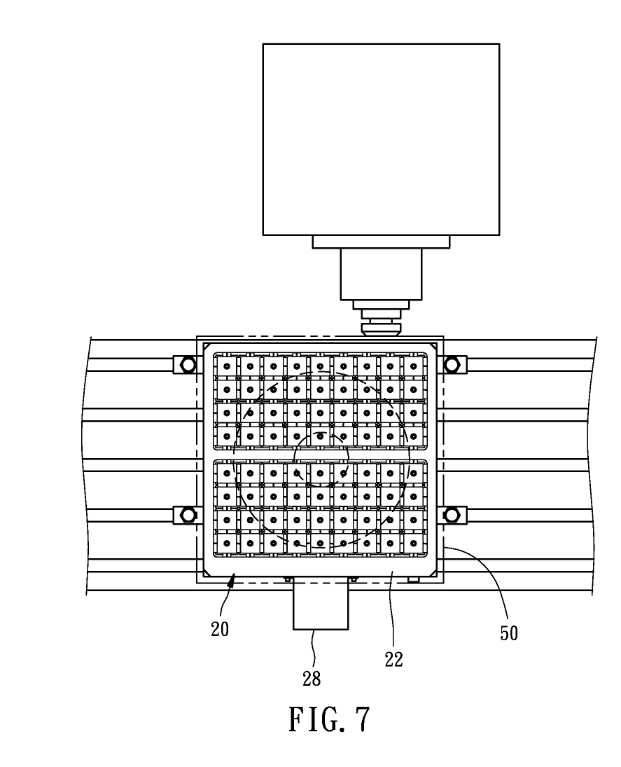

As shown in FIG. 7, when the present invention is applied to a horizontal processing machine machining a stationary workpiece 50, the workpiece 50 is first mounted onto the working surface 40, a controller (not shown) is connected with the electric connector 29, and then the magnetizing coils 36 are electrically conducted by forward current via the controller. When the magnetizing coils 36 are electrically conducted, the magnetic-conductive members 34 generate the magnetic fields therebetween on the working surface 40 to well magnetically stick the workpiece 50 to the working surface 40, and then the controller can be detached from the carrier 20.

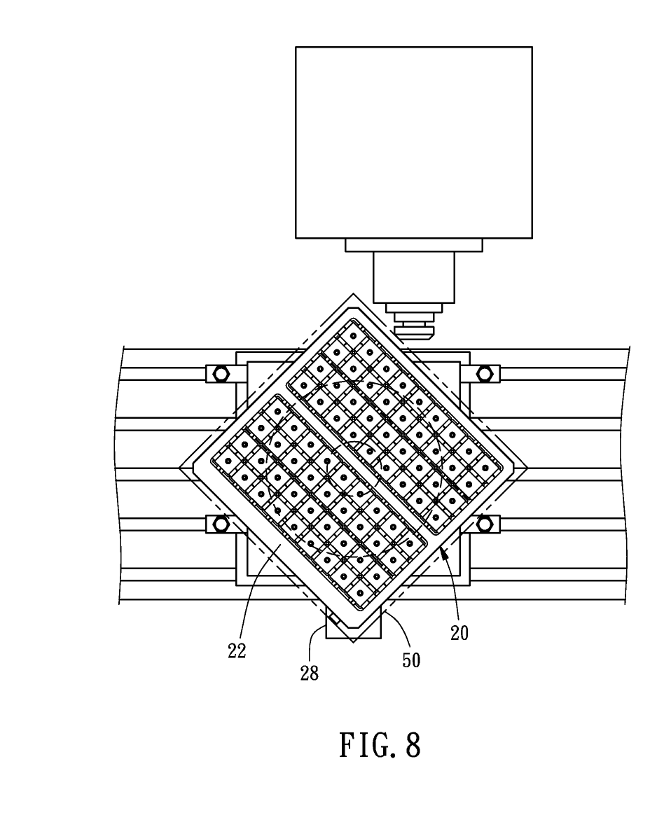

While machining the workpiece 50, as shown in FIG. 8, the user merely needs to operate the positioning member 28 to drive rotation of the carrier 20 with respect to the chassis 12 and then the processing machine can machine the workpiece 50 along its external periphery. After the processing is done, the user can connect the controller with the electric connector 29 to conduct the magnetizing coils 36 with the reverse current, such that the polarities of the magnetic-conductive members 34 are changed to disable the magnetic fields on the working surface 40. In this way, the workpiece is no longer stuck to the working surface 40 and thus the processed workpiece 50 can be moved away from the carrier 20.

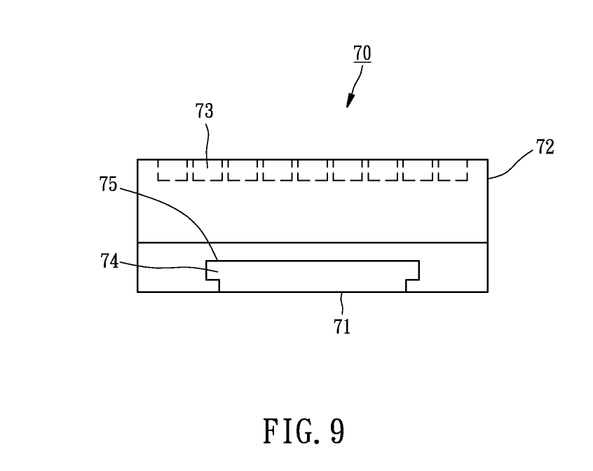

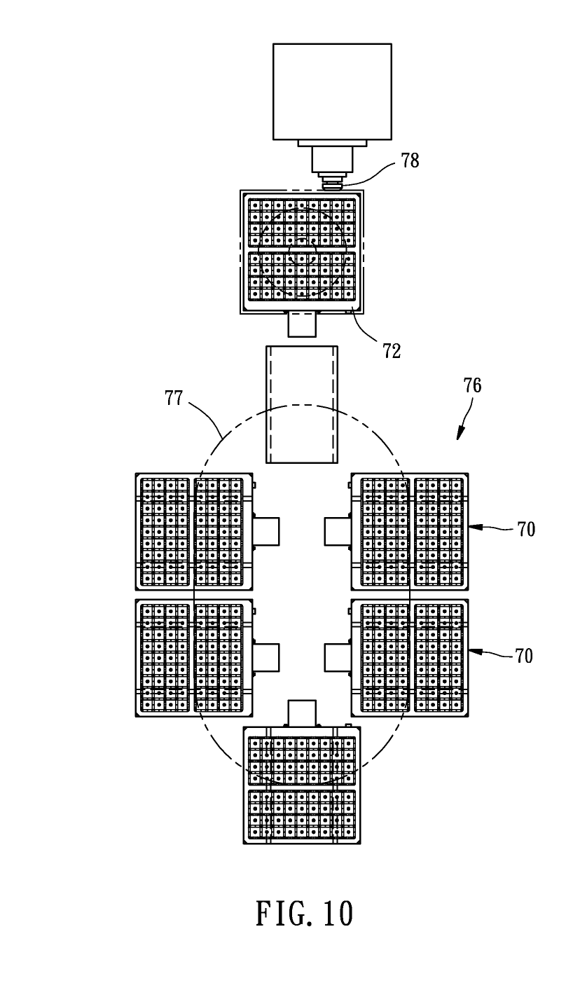

Referring to FIG. 9, a permanent electromagnetic indexing apparatus 70 in accordance with a second embodiment of the present invention is also composed of a chassis 71, a carrier 72, and a plurality of magnetic sets 73 as that of the first embodiment is, being different from the second embodiment in that the chassis 71 includes a dovetail portion 74 and the carrier 72 includes a connection part 75 for connection with the dovetail portion 74. The carrier 72 is detachably mounted to the chassis 71. When the present invention is applied to a horizontal switching workbench 76 shown in FIG. 10, a plurality of the permanent electromagnetic indexing apparatuses 70 are movably mounted to a circumrotary track 77 of a horizontal processing machine and the respective carriers 72 of the permanent electromagnetic indexing apparatuses 70 can be moved away from or connected with the chassis 71 corresponding to a cutter 78. In this way, the cutter 78 can variably process workpieces fixed to the respective carriers 72 to increase the production utilization and the processing efficiency.

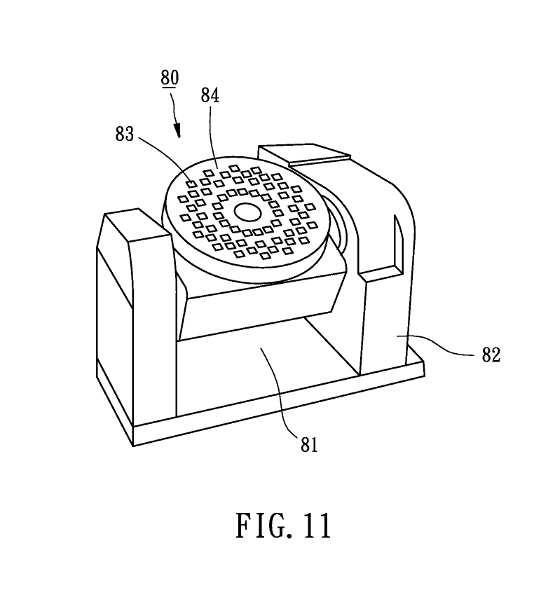

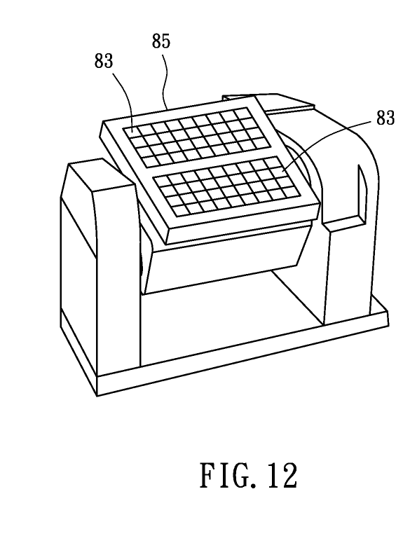

Referring to FIG. 11, a permanent electromagnetic indexing apparatus 80 in accordance with a third embodiment of the present invention is characterized in that the chassis 81 is rotatably mounted to a base 82 of a computer and control (CNC) indexing plate, and the magnetic sets 83 are arranged annularly on a round carrier 84 or on a polygonal carrier 85 in matrix as shown in FIG. 12. In this way, the present invention can be applied to a five-axis processing machine tool to enhance the workability.

In conclusion, the present invention includes the following advantages.

1. The workpiece can be held stably and directly fixed to the carrier without any jig, simplifying the processing procedure and time.

2. When the carrier is rotatable with respect to the carrier, none of any dead angles happens within the area that the workpiece is processed, such that the present invention can enhance the workability to enable more flexible and variable processing.

3. Compared with the conventional magnet-type magnetic set, the magnetic set of the present invention does not increase the temperature after the present invention is operated to have longer working life.

4. Because each of the magnetic sets functions based on the interaction between the permanent magnet and the magnetic-conductive magnet and the magnetism of the magnetic sets is greater after the magnetizing coils are magnetized, the magnetic sets can maintain their magnetism even if the blackout happens.

Although the present invention has been described with respect to specific preferred embodiments thereof, it is no way limited to the details of the illustrated structures but changes and modifications may be made within the scope of the appended claims.

What is claimed is:

1. A permanent electromagnetic indexing apparatus comprising:
a chassis;
a carrier having a receiving portion and a connection part, said connection part being pivoted to said chassis; and
at least two magnetic sets, each of which has a first permanent magnet, a magnetic-conductive member, a second permanent magnet, and a magnetizing coil, each of said first permanent magnets being mounted to said magnetic-conductive member, each of said magnetic-conductive member being mounted to said second permanent magnet, each of said magnetizing coils surrounding said second permanent magnet, said magnetic sets being mounted to said receiving portion of said carrier, said magnetic-conductive members becoming a working surface on which a workpiece can be put; wherein
when each of said magnetizing coils is electrically conducted, the polarity of each of said magnetic-conductive members can be further changed and thus said workpiece can be fixed to or removed from said working surface.

2. The permanent electromagnetic indexing apparatus as defined in claim 1, wherein said carrier comprises a top side; said receiving portion is recessed from said top side; and said magnetic sets are arranged in matrix in said receiving portion.

3. The permanent electromagnetic indexing apparatus as defined in claim 1, wherein each of said first permanent magnet comprises a plurality of magnetic strips mounted to an external periphery of said magnetic-conductive member.

4. The permanent electromagnetic indexing apparatus as defined in claim 1, wherein said carrier comprises an electric connector electrically connected with said magnetizing coils.

5. The permanent electromagnetic indexing apparatus as defined in claim 1 further comprising a plurality of chocks mounted to said magnetic sets respectively.

6. The permanent electromagnetic indexing apparatus as defined in claim 1, wherein said chassis is pivoted to a base.

7. A permanent electromagnetic indexing apparatus comprising:
a chassis;
a carrier having a receiving portion and a connection part, said connection part being detachably mounted to said chassis; and
at least two magnetic sets, each of which has a first permanent magnet, a magnetic-conductive member, a second permanent magnet, and a magnetizing coil, each of said first permanent magnets being mounted to said magnet-conductive member, each of said magnet-conductive members being mounted onto said second permanent member, each of said magnetizing coils surrounding said second permanent magnet, said magnetic sets being mounted to said receiving portion of said carrier, said magnetic-conductive members becoming a working surface on which a workpiece can be put; wherein
when each of said magnetizing coils is electrically conducted, the polarity of each of said magnetic-conductive members can be changed and then said workpiece can be fixed to or removed from said working surface.

8. The permanent electromagnetic indexing apparatus as defined in claim 7, wherein said carrier comprises a top side; said receiving portion is recessed from said top side; and said magnetic sets are arranged in matrix in said receiving portion.

9. The permanent electromagnetic indexing apparatus as defined in claim 7, wherein each of said first permanent magnets comprises a plurality of magnetic strips, said magnetic strips being mounted to an external periphery of said magnetic-conductive member.

10. The permanent electromagnetic indexing apparatus as defined in claim 7, wherein said carrier comprises an electric connector and said magnetizing coils are electrically connected with said electric connector.

11. The permanent electromagnetic indexing apparatus as defined in claim 7 further comprising a plurality of chocks mounted onto said magnetic sets respectively.

12. The permanent electromagnetic indexing apparatus as defined in claim 7, wherein said chassis is pivoted to a base.
